(19) United States
(12) Patent Application Publication
(10) Pub. No.: US 2015/0109973 A1
(43) Pub. Date: Apr. 23, 2015

(54) Channel State Information (CSI) Report Subsets Under Flexible Time Division Duplex (TDD) UL/DL Configuration

(71) Applicants: Chun Hai Yao, Beijing (CN); Li Zhang, Beijing (CN)

(72) Inventors: Chun Hai Yao, Beijing (CN); Li Zhang, Beijing (CN)

(73) Assignee: Nokia Solutions and Networks Oy, Espoo (FI)

(21) Appl. No.: 14/400,371

(22) PCT Filed: May 11, 2012
(86) PCT No.: PCT/CN2012/075376

§ 371 Date: Nov. 11, 2014

(51) Int. Cl. H04W 72/04; H04L 5/14

(52) U.S. Cl. CPC H04W 72/042; H04L 5/14
USPC 370/280

(57) ABSTRACT

A method for flexible time division duplex (TDD) UL/DL configuration is provided. The method includes designating all subframes in a time division duplex configuration as downlink subframes, with the exception of any subframes scheduled for uplink data and control transmission. The method then includes monitoring downlink control channels in the subframes designated as downlink subframes, and defining at least two different channel state information (CSI) report subframe subsets according to interference levels.

### BACKGROUND

1. Field

Embodiments of the invention generally relate to wireless communications networks, such as, but not limited to, the Universal Mobile Telecommunications System (UMTS) Terrestrial Radio Access Network (UTRAN) and/or Long Term Evolution (LTE) Evolved UTRAN (E-UTRAN). Some embodiments may relate to flexible Time Division Duplex (TDD) configuration in LTE-Advanced (LTE-A).

2. Description of the Related Art

Universal Mobile Telecommunications System (UMTS) Terrestrial Radio Access Network (UTRAN) refers to a communications network including base stations, or Node Bs, and radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE is also expected to improve spectral efficiency in 3G networks, allowing carriers to provide more data and voice services over a given bandwidth. Therefore, LTE is designed to fulfill future needs for high-speed data and media transport in addition to high-capacity voice support. Advantages of LTE include high throughput, low latency, FDD and TDD support in the same platform, an improved end-user experience, and a simple architecture resulting in low operating costs.

Further releases of 3GPP LTE (e.g., LTE Rel-10, LTE-Rel-11) are targeted towards future international mobile telecommunications advanced (IMT-A) systems, referred to herein for convenience simply as LTE-Advanced (LTE-A).

LTE-A is, in part, directed toward extending and optimizing the 3GPP LTE radio access technologies to provide higher data rates and lower latency with reduced cost. LTE-A will be a more optimized radio system fulfilling the international telecommunication union-radio (ITU-R) requirements for IMT-Advanced while keeping the backward compatibility.

### SUMMARY

One embodiment is directed to a method including designating all subframes in a time division duplex configuration as downlink subframes, with the exception of any subframes scheduled for uplink data and control transmission. The method may further include monitoring downlink control channels in the subframes designated as downlink subframes, and defining at least two different channel state information (CSI) report subframe subsets according to interference levels.

Another embodiment includes an apparatus which may include at least one processor and at least one memory comprising computer program code. The at least one memory and the computer program code may be configured, with the at least one processor, to cause the apparatus at least to designate all subframes in a time division duplex configuration as downlink subframes, with the exception of any subframes scheduled for uplink data and control transmission, to monitor downlink control channels in the subframes designated as downlink subframes, and to define at least two different channel state information (CSI) report subframe subsets according to interference levels.

Another embodiment may include a computer program, embodied on a computer readable medium. The computer program may be configured to control a processor to perform a process including designating all subframes in a time division duplex configuration as downlink subframes, with the exception of any subframes scheduled for uplink data and control transmission, monitoring downlink control channels in the subframes designated as downlink subframes, and defining at least two different channel state information (CSI) report subframe subsets according to interference levels.

Another embodiment may include an apparatus comprising means for designating all subframes in a time division duplex configuration as downlink subframes, with the exception of any subframes scheduled for uplink data and control transmission, means for monitoring downlink control channels in the subframes designated as downlink subframes, and means for defining at least two different channel state information (CSI) report subframe subsets according to interference levels.

Another embodiment is directed to a method including receiving at least one channel state information (CSI) report from a user equipment. The at least one channel state information (CSI) report may include at least two different channel state information (CSI) report subframe subsets defined according to the interference levels. The method may further include scheduling the user equipment according to the channel state information (CST) report subframe subsets.

Another embodiment includes an apparatus which may include at least one processor and at least one memory comprising computer program code. The at least one memory and the computer program code may be configured, with the at least one processor, to cause the apparatus at least to receive at least one channel state information (CSI) report from a user equipment. The at least one channel state information (CSI) report may include at least two different channel state information (CSI) report subframe subsets defined according to the interference levels. The at least one memory and the computer program code may be further configured, with the at least one processor, to cause the apparatus at least to schedule the user equipment according to the channel state information (CSI) report subframe subsets.

Another embodiment may include an apparatus comprising means for receiving at least one channel state information (CSI) report from a user equipment. The at least one channel state information (CSI) report may include at least two different channel state information (CSI) report subframe subsets defined according to the interference levels. The apparatus may further include means for scheduling the user equipment according to the channel state information (CSI) report subframe subsets.

Another embodiment may include a computer program, embodied on a computer readable medium. The computer program may be configured to control a processor to perform a process including receiving at least one channel state information (CSI) report from a user equipment. The at least one channel state information (CSI) report may include at least two different channel state information (CSI) report subframe subsets defined according to the interference levels. The process may further include scheduling the user equipment according to the channel state information (CSI) report subframe subsets.

### BRIEF DESCRIPTION OF THE DRAWINGS

For proper understanding of the invention, reference should be made to the accompanying drawings, wherein:

FIG. 1 illustrates a system according to one embodiment;

FIG. 2 illustrates an example of a table of TDD UL/DL configuration according to an embodiment;

FIG. 3 illustrates an apparatus according to one embodiment;

FIG. 4 illustrates a flow diagram of a method according to one embodiment; and

FIG. 5 illustrates a flow diagram of a method according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of a system, a method, an apparatus, and a computer program product for flexible TDD UL/DL configuration in LTE as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Embodiments of the invention relate to LTE TDD interference management and traffic adaption (eIMTA), i.e., flexible TDD UL/DL configuration. According to certain embodiments, TDD enhanced Node Bs (eNBs) can change the uplink (UL)/downlink (DL) configuration in the next 10 ms, 200 ms or 640 ms to adapt the traffic in UL and DL, so as to improve the system performance and provide a better user experience.

Under flexible TDD UL/DL configuration, from the UE perspective, the UE may always be monitoring the possible DL subframes to find the possible scheduled physical DL control channel (PDSCH) and physical uplink shared channel (PUSCH). However, one problem is that the DL subframe interference will be different from subframe 0/1/5/6 to other downlink subframes, because other DL subframes may be uplink subframes for other eNBs with different UL/DL configuration.

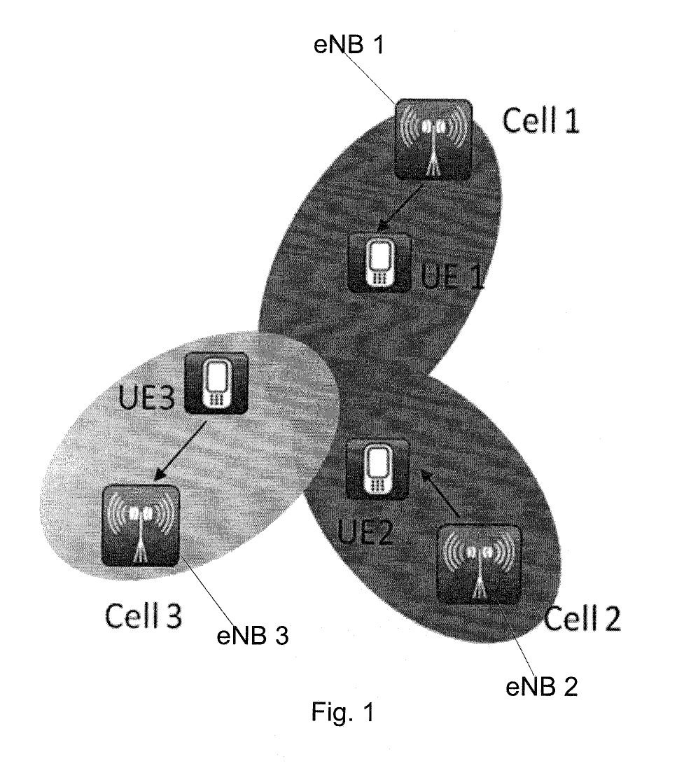

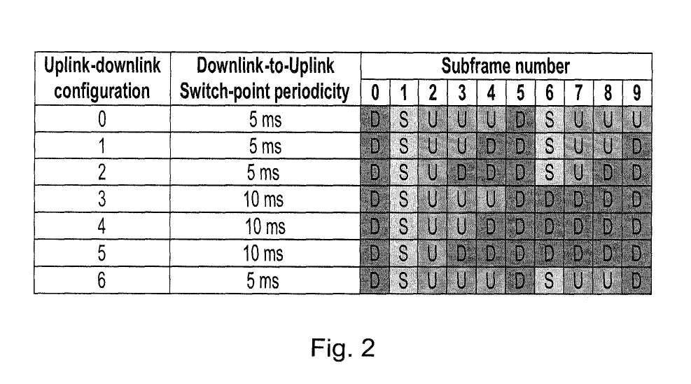

FIG. 1 illustrates an example of a system of different cells with different UL/DL configurations, according to an embodiment. FIG. 2 illustrates an example of a TDD UL/DL configuration table, according to one embodiment. In the examples depicted in FIGS. 1 and 2, cell 1 deploys configuration 1, cell 2 uses configuration 2, and cell 3 uses configuration 0. In this example, subframe 0 and subframe 1 are always downlink subframes for all three cells. In subframe 4, as depicted in FIG. 1, UE I will receive eNB 2 (cell 2) downlink interference and eNB 3 (cell 3) uplink interference. The interference UE 1 receives from subframe 0 and subframe 4 are different. If UE 1 reports only one channel state information (CSI) report with information collected from all downlink subframes, the interference will fluctuate so much in the different subframes so as to cause the UE to be wrongly scheduled according to the CSI report.

Previously, the eNB would not change the UL/DL configuration to avoid additional interference, or at least the UL/DL configuration change would be semi-static, such as a change after 640 ms. In this case, the interference change will not be much. However, if the UL/DL configuration transient time is as fast as 10 ms, the interference fluctuation from different subframes is unavoidable, and this will cause a scheduling problem for the eNB.

Under half duplex FDD operation and inter-band TDD CA with half duplex UE, the problem has been considered as to how the UE can dynamically determine whether a subframe is UL or DL. One solution is that if there is an UL transmission scheduled/configured in a subframe (which could be known at least 4 ms before), the UE will consider the subframe as UL; otherwise, the subframe will be considered as DL.

However, the above solution cannot be directly applied to TDD eIMTA. It is possible that one UE may have no UL transmission and, thus, assume a subframe as DL, but in fact the eNB is scheduling other UEs in UL. In half duplex FDD operation or inter-band TDD CA, there is no such problem because UL and DL cannot occur at the same time on the same frequency.

Embodiments of the invention are able to provide more accurate CSI reports, which can then allow for proper and more efficient scheduling of UEs. In one embodiment, the UE is configured to assume that all the subframes are DL subframes and monitor DL control channels in these subframes, with the exception of subframes scheduled for UL transmission. For example, according to the table of FIG. 2, subframe 2 is always UL subframe in any UL/DL configuration. Accordingly, in that example, subframe 2 will be considered a UL subframe. Further, according to an embodiment, for the subframe(s) in which the UE is scheduled for UL data and control transmission, the UE assumes that this subframe is a UL subframe. The UE knows this at the DL scheduling subframe, i.e., at least four subframes before.

As a result, according to an embodiment, there is no need for the network (eNB) to inform the serving UE of detailed UL/DL configuration. In fact, the network may not be able to provide accurate UL/DL configuration information because the UL/DL change is so fast in comparison to the system information change. Thus, in this embodiment, the UE can detect which subframe(s) is a downlink subframe automatically through decoding DL control channels; for example, if the UE cannot correctly decode the physical control format indicator channel (PCFICH), it will assume this subframe is a UL subframe and stop any CSI measurement in this subframe.

Embodiments then define different CSI report subframe subsets according to the interference levels. For example, subframes 0, 1, 5, 6 can be considered one CSI report subset (1st subset), in which all the neighboring cells are DL. The UE will experience the same interference in this subset. Subframes 3, 4, 7, 8, 9, for instance, may be considered another CSI report subset (2nd subset). In this 2nd subset, the UE-experienced interference may vary significantly in each subframe, because each of the neighboring cells could be every UL/DL configuration of seven possible configurations. These two CSI report subframe subsets may be configured by the serving eNB and informing UE via higher layer signaling or broadcast in system information. CSI reports can be aperiodic or periodic report according to eNB configuration.

In one embodiment, measurements for mobility and radio link failure (RLF) are only collected from subframes 0, 1, 5, 6 (1st subset).

According to an embodiment, in a constant interference CSI report subframe subset (1st subset), the UE can perform channel quality indicator (CQI) measurements on the subframes in this subset. The eNB receives the CSI report and schedules the UE in the subframe(s) of this subset. In this subset, the CSI report information is accurate, and, based on this information, the eNB can improve the scheduling efficiency in the subset subframes.

According to an embodiment, in the other CSI report subset (2nd subset), it is a UL or DL subframe from its neighboring eNB depending on the neighboring eNB traffic status. Therefore, UE CQI measurement results may not be very stable, and the eNB cannot necessarily rely on the accuracy of these reports. As a result, the eNB scheduling UEs in subframes of this 2nd subset will be more dependent on schedule strategy and the eNB's own measurements which may depend on the eNB's capabilities and the UL/DL configuration information exchange between eNBs. Configuration on CSI reporting could be quite different from that of the 1st subset, and one embodiment is configured to provide no CQI report (only PMI/RI report) in the case of 10 ms transient periodicity, for example. It should be noted that the 2nd subset could also be split further in case of 200 ms or 640 ms transient periodicity, according to one embodiment.

Therefore, according to embodiments of the invention, the eNB will receive a more accurate CSI report from the different report subsets, so that it can better choose the proper subframe for scheduling the UEs.

In one embodiment, as mentioned above, 10 ms UL/DL configuration transient periodicity may be used. So in the next radio frame, the eNB cannot predict neighboring cell UL/DL configuration and, therefore, cannot predict the interference. This also results in difficulty scheduling the UE(s). Embodiments of the invention discussed above are able to overcome these issues.

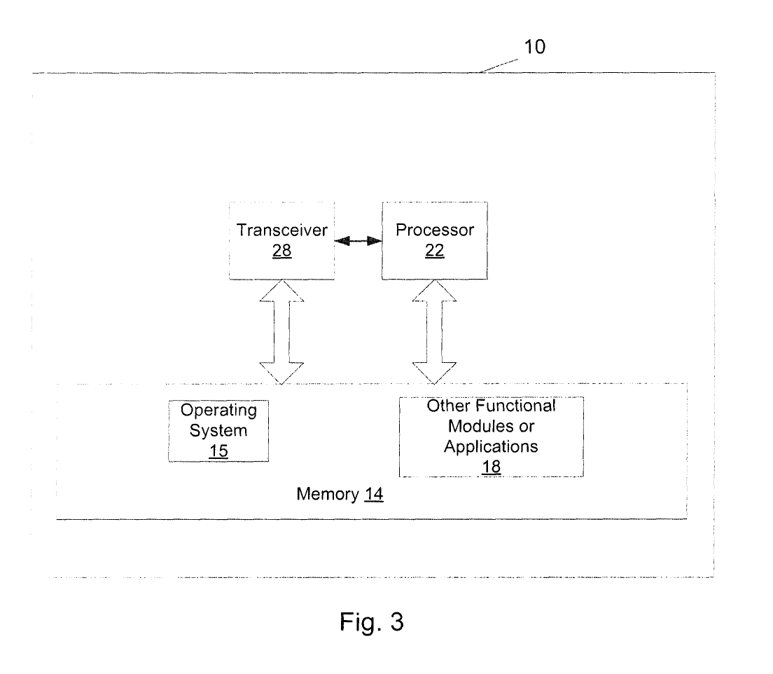

FIG. 3 illustrates an apparatus 10 according to another embodiment. In an embodiment, apparatus 10 may be a UE supporting flexible TDD UL/DL configuration. In other embodiments, apparatus 10 may be an eNB supporting flexible TDD UL/DL configuration. It should be noted that one of ordinary skill in the art would understand that apparatus 10 may include components or features not shown in FIG. 3. Only those components or feature necessary for illustration of the invention are depicted in FIG. 3.

As illustrated in FIG. 3, apparatus 10 includes a processor 22 for processing information and executing instructions or operations. Processor 22 may be any type of general or specific purpose processor. While a single processor 22 is shown in FIG. 34, multiple processors may be utilized according to other embodiments. In fact, processor 22 may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

As mentioned above, according to one embodiment, apparatus 10 may be a UE. In this embodiment, apparatus 10 may be controlled by memory 14 and processor 22 to assume or designate all subframes as being DL subframes, except for those subframe(s) in which apparatus 10 is scheduled for UL data and control transmission. Apparatus 10 may be further controlled by memory 14 and processor 22 to monitor DL control channels in the subframes designated as DL subframes. Apparatus 10 may then be further controlled by memory 14 and processor 22 to define at least two different CSI report subframe subsets according to the interference levels. For example, a 1st subset may include those subframes in which all the neighboring cells are DL, and a 2nd subset may include those subframes in which each neighboring cell may be UL or DL. In this example, the 2nd subset may be such that the UE-experienced interference varies significantly in each subframe because each of the neighboring cells could be every UL/DL configuration of seven possible configurations. In one embodiment, apparatus 10 is further controlled by memory 14 and processor 22 to collect measurements for mobility and RLF only from the 1st subset.

According to another embodiment, apparatus 10 may be an eNodeB. In this embodiment, apparatus 10 may be controlled by memory 14 and processor 22 to receive one or more CSI reports from a UE. The received CSI report(s) may include at least two different CSI report subframe subsets defined according to the interference levels, as discussed above. Apparatus 10 may then be controlled by memory 14 and processor 22 to schedule UEs according to the CSI report subframe subsets. As a result of these steps apparatus 10 will have a more accurate CSI report form the different report subsets so that it can select the proper subframe in which to schedule the UEs.

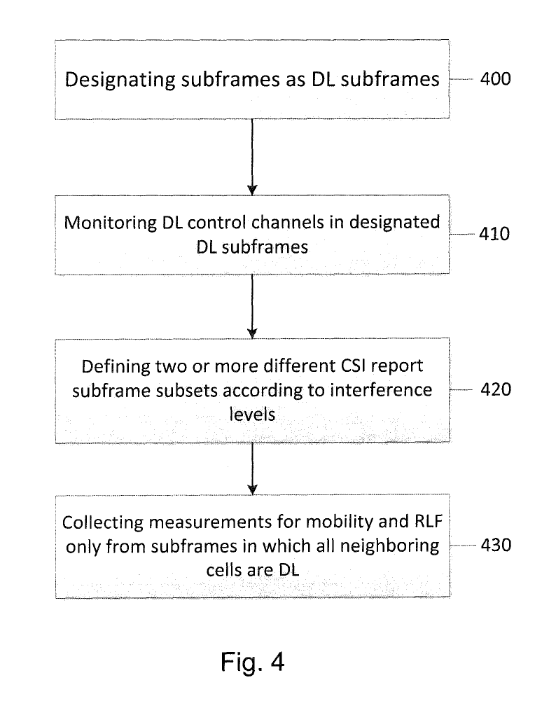

FIG. 4 illustrates a flow diagram of a method according to one embodiment. The method includes, at 400, designating all subframes as DL subframes, except for those subframe(s) scheduled for UL data and control transmission. The method may also include, at 410, monitoring DL control channels in the subframes designated as DL subframes. At 420, the method includes defining at least two different CSI report subframe subsets according to the interference levels. For example, a 1st subset may include those subframes in which all the neighboring cells are DL, and a 2nd subset may include those subframes in which each neighboring cell may be UL or DL. The method may then include, at 430, collecting measurements for mobility and radio link monitor (RLM) only from the subframes in which all neighboring cells are DL (e.g., 1st subset).

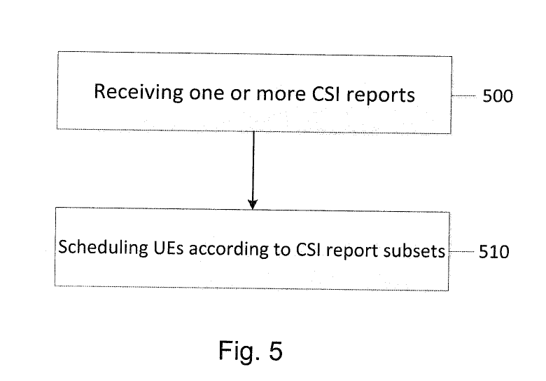

FIG. 5 illustrates a flow diagram of a method according to one embodiment. The method includes, at 500, receiving one or more CSI reports from a UE. The received CSI report(s) may include at least two different CSI report subframe subsets defined according to the interference levels, as discussed above. The method may then include, at 510, scheduling UEs according to the CSI report subframe subsets.

According to certain embodiments, the functionality of the flow diagram of FIGS. 4 and 5, or that of any other method described herein, may be implemented by software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

The computer readable media mentioned above may be at least partially embodied by a transmission line, a compact disk, digital-video disk, a magnetic disk, holographic disk or tape, flash memory, magnetoresistive memory, integrated circuits, or any other digital processing apparatus memory device.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
designating all subframes in a time division duplex configuration as downlink subframes, with the exception of any subframes scheduled for uplink data and control transmission;
monitoring downlink control channels in the subframes designated as downlink subframes; and
defining at least two different channel state information (CSI) report subframe subsets according to interference levels.

2. The method according to claim 1, further comprising collecting measurements for mobility and radio link monitor (RLM) only from the subframes in which all neighboring cells are downlink.

3. The method according to claim 1, wherein one of the at least two different channel state information (CSI) report subframe subsets comprises those subframes in which all the neighboring cells are downlink.

4. The method according to claim 1, wherein the subframes in which all the neighboring cells are downlink comprises subframes 0, 1, 5, 6.

5. The method according to claim 1, wherein another one of the at least two different channel state information (CSI) report subframe subsets comprises those subframes in which each neighboring cell may be uplink or downlink.

6. The method according to claim 1, wherein the subframes in which each neighboring cell may be uplink or downlink comprises subframes 3, 4, 7, 8, 9.

7. The method according to claim 1, wherein downlink-to-uplink reconfiguration periodicity comprises 10 ms, 200 ms, 640 ms or other periodicities.

8. The method according to claim 1, wherein the channel state information (CSI) report subframe subsets are configured by an eNB, and the subsets are informed to UE through higher layer signaling or system broadcast information.

9. An apparatus, comprising:
at least one processor; and
at least one memory including computer program code,
the at least one memory and the computer program code configured, with the at least one processor, to cause the apparatus at least to
designate all subframes in a time division duplex configuration as downlink subframes, with the exception of any subframes scheduled for uplink data and control transmission;
monitor downlink control channels in the subframes designated as downlink subframes; and
define at least two different channel state information (CSI) report subframe subsets according to interference levels.

10. The apparatus according to claim 9, wherein the at least one memory and the computer program code are further configured, with the at least one processor, to cause the apparatus at least to collecting measurements for mobility and radio link monitor (RLM) only from the subframes in which all neighboring cells are downlink.

11. The apparatus according to claim 10, wherein one of the at least two different channel state information (CSI) report subframe subsets comprises those subframes in which all the neighboring cells are downlink.

12. The apparatus according to claim 9, wherein another one of the at least two different channel state information (CSI) report subframe subsets comprises those subframes in which each neighboring cell may be uplink or downlink.

13. The apparatus according to claim 9, wherein the apparatus comprises user equipment.

14. A computer program, embodied on a computer readable medium, the computer program configured to control a processor to perform a process, comprising:
designating all subframes in a time division duplex configuration as downlink subframes, with the exception of any subframes scheduled for uplink data and control transmission;
monitoring downlink control channels in the subframes designated as downlink subframes; and
defining at least two different channel state information (CSI) report subframe subsets according to interference levels.

15. A method, comprising:
receiving at least one channel state information (CSI) report from a user equipment, wherein the at least one channel state information (CSI) report comprises at least two different channel state information (CSI) report subframe subsets defined according to the interference levels; and
scheduling the user equipment according to the channel state information (CSI) report subframe subsets.

16. The method according to claim 15, wherein one of the at least two different channel state information (CSI) report subframe subsets comprises those subframes in which all the neighboring cells are downlink.

17. The method according to claim 15, wherein the subframes in which all the neighboring cells are downlink comprises subframes 0, 1, 5, 6.

18. The method according to claim 15, wherein another one of the at least two different channel state information (CSI) report subframe subsets comprises those subframes in which each neighboring cell may be uplink or downlink.

19. The method according to claim 15, wherein the subframes in which each neighboring cell may be uplink or downlink comprises subframes 3, 4, 7, 8, 9.

20. The method according to claim 15, wherein downlink-to-uplink reconfiguration periodicity comprises 10 ms, 200 ms, 640 ms or other periodicities.

21. The method according to claim 15, further comprising configuring the channel state information (CSI) report subframe subsets, and informing the subsets to the user equipment through higher layer signaling or system broadcast information.

22. An apparatus, comprising:
at least one processor; and
at least one memory including computer program code,
the at least one memory and the computer program code configured, with the at least one processor, to cause the apparatus at least to
receive at least one channel state information (CSI) report from a user equipment, wherein the at least one channel state information (CSI) report comprises at least two different channel state information (CSI) report subframe subsets defined according to the interference levels; and
schedule the user equipment according to the channel state information (CSI) report subframe subsets.

23. The apparatus according to claim 22, wherein one of the at least two different channel state information (CSI) report subframe subsets comprises those subframes in which all the neighboring cells are downlink.

24. The apparatus according to claim 22, wherein another one of the at least two different channel state information (CSI) report subframe subsets comprises those subframes in which each neighboring cell may be uplink or downlink.

25. The apparatus according to claim 22, wherein downlink-to-uplink reconfiguration periodicity comprises 10 ms, 200 ms, 640 ms or other periodicities.

26. The apparatus according to claim 22, wherein the at least one memory and the computer program code are further configured, with the at least one processor, to cause the apparatus at least to configure the channel state information (CSI) report subframe subsets, and to inform the subsets to UE through higher layer signaling or system broadcast information.

27. The apparatus according to claim 20, wherein the apparatus comprises an eNodeB.

28. A computer program, embodied on a computer readable medium, the computer program configured to control a processor to perform a process, comprising:
receiving at least one channel state information (CSI) report from a user equipment, wherein the at least one channel state information (CSI) report comprises at least two different channel state information (CSI) report subframe subsets defined according to the interference levels; and
scheduling the user equipment according to the channel state information (CSI) report subframe subsets
